(19) United States
(12) Patent Application Publication
(10) Pub. No.: US 2007/0193631 A1
(43) Pub. Date: Aug. 23, 2007

(54) PRESSURE REDUCING VALVE

(76) Inventors: Peter Lauer, Lohr (DE); Guenter Krenzer, Eussenheim (DE)

Correspondence Address: Striker, Striker & Stenby, 103 East Neck Road, Huntington, NY, 11743, US

(21) Appl. No.: 11/676,383

(22) Filed: Feb. 19, 2007

(30) Foreign Application Priority Data
Feb. 21, 2006 (DE) 10 2006 008 024.6

(51) Int. Cl. G05D 16/10

(52) U.S. Cl. 137/505.25; 137/508

(57) ABSTRACT

A pressure reducing valve, for a clamping device in particular, has a control plunger, which is acted upon by a regulating pressure against an adjustable force, and a closing body which is preloaded against a valve seat in the closing direction by the force of a compression spring. The closing body is movable from its closed position into its opened position, past the valve seat, via a transfer element, thereby allowing control of the flow of pressure medium from a pressure inlet to a regulating pressure outlet. The control plunger is designed as a hollow piston in order to accommodate the closing body, and it forms the valve seat for the closing body which is guided in the control plunger.

### CROSS-REFERENCE TO A RELATED APPLICATION

The invention described and claimed hereinbelow is also described in German Patent Application DE 10 2006 008 024.6 filed on Feb. 21, 2006. This German Patent Application, whose subject matter is incorporated here by reference, provides the basis for a claim of priority of invention under 35 U.S.C. 119(a)-(d).

### BACKGROUND OF THE INVENTION

The present invention relates to a pressure reducing valve, for a clamping device in particular.

With pressure reducing valves of this type, e.g., that are used in hydraulic clamping devices of machine tools, an inlet pressure is reduced to, or an outlet pressure (regulating pressure) is held constant at a pressure that is less than the system pressure in the main circuit. To accomplish this, the outlet pressure is directed toward the end face of a control plunger. There it is compared hydraulically with an adjusted force, e.g., the force of a control spring with an adjustable preload, or the force of a proportional magnet that determines the value of the regulating pressure. If the hydraulic force exceeds the adjusted force, the control plunger moves in the closing direction of a closing body which interrupts the flow of pressure medium to the regulating pressure outlet.

A pressure reducing valve of this type is made known, e.g., in EP 0 955 472 B1. This conventional pressure reducing valve for regulating an inlet pressure to an adjustable value has a valve housing with a first chamber which is separated from a second chamber by a valve seat of a housing insert. The first chamber is connected with an inlet connection for the inlet pressure, while the second chamber is connected with a connection for the outlet pressure. A closing body is located in the second chamber; the closing body is movable relative to the valve seat out of a leak-proof, spring-preloaded, closed position in the opening direction.

The closing body can be moved into its opened position via a plunger, past the valve seat, using a control plunger which is acted upon by a force of a control spring that is directed in the opening direction of the closing body. The disadvantage of pressure reducing valves of this type is that they have a long overall length and require a great deal of fabrication outlay, due to the coaxial positioning of the closing body and the control plunger. Additional fabrication outlay is required in particular for the housing insert, which is required to design the valve seat due to the poor accessibility of the middle sections of the valve bore.

### SUMMARY OF THE INVENTION

The object of the present invention, therefore, is to create a pressure reducing valve that results in a shorter overall length using the simplest design possible.

The inventive pressure reducing valve includes a control plunger which is acted upon against an adjustable force by a regulating pressure, and a closing body which is preloaded against a valve seat in the closing direction by the force of a compression spring. The closing body is movable from its closed position into an opened position, past the valve seat, via a transfer element, thereby enabling control of the flow of pressure medium from a pressure inlet to a regulating pressure outlet.

According to the present invention, the control plunger is designed as a hollow piston to accommodate the closing body, and it forms the valve seat for the closing body which is guided in the control plunger. By accommodating the closing body in the control plunger, the inventive means of attaining the object of the present invention results in a much shorter overall length of the pressure reducing valve as compared with the related art, as described in EP 0 955 472 B1. In addition, the valve seat of the closing body in the control plunger is designed such that a housing insert is not required in the valve bore. The manufacture of the pressure reducing valve is therefore simplified considerably, since the valve housing has a relatively simple design with fewer required components, and it is easily accessed for production.

According to a preferred exemplary embodiment of the present invention, the control plunger is guided in a valve bore and, with the valve bore and via an end face, it bounds a control chamber that is acted upon by a regulating pressure.

The control chamber is preferably connected with the regulating pressure outlet via at least one control channel.

According to a particularly simple means of attaining the object of the present invention, a housing-mounted plunger is used as the transfer element, which supports the closing body in the opened position past the valve seat against the force of the compression spring. The diameter of the plunger is smaller than the diameter of the valve seat, thereby resulting in an annular flow channel between the plunger and the valve seat.

In a preferred embodiment of the present invention, the inner space of the control plunger is acted upon with the inlet pressure via at least one radial bore in the control plunger. The radial bores preferably lead into the inner space of the control plunger in the region of the closing body, thereby shortening the flow path and reducing the flow resistance. A ball is preferably used as the closing body.

In one exemplary embodiment of the pressure reducing valve, the radial bores lead into a circumferential annular groove or a pocket that is provided on the outer circumference of the control plunger and is connected with the pressure inlet via at least one pressure channel.

To monitor pressure, the control plunger is preferably operatively connected with a pressure monitoring sensor, e.g., an electrical switch, the switching point of which is adjusted to the regulated pressure or a lower value. When the pressure—which is to be regulated at the regulating outlet—has reached the clamping pressure for a tool, for example, the pressure switch is actuated.

The control plunger preferably has a radial collar which interacts with at least one housing-mounted stop. This limits the displacement travel of the control plunger.

According to a particularly simple means of attaining the object of the present invention, the control plunger actuates the pressure monitoring sensor via the radial collar.

In one exemplary embodiment of the present invention, the force that acts on the control plunger in the opening direction is applied by at least one control spring or a proportional magnet. The preload on the control spring is preferably adjustable using an adjusting element, an adjusting spindle in particular, in order to change the regulating pressure.

The pressure inlet is sealed by at least one radial seal against the regulating pressure outlet and against the chamber with the control spring or the proportional magnet.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a longitudinal cross section through an inventive pressure reducing valve, and

FIG. 2 shows a longitudinal cross section in the region of the control plunger through an inventive pressure reducing valve according to a further exemplary embodiment.

### DESCRIPTION OF THE PREFERRED EMBODIMENTS

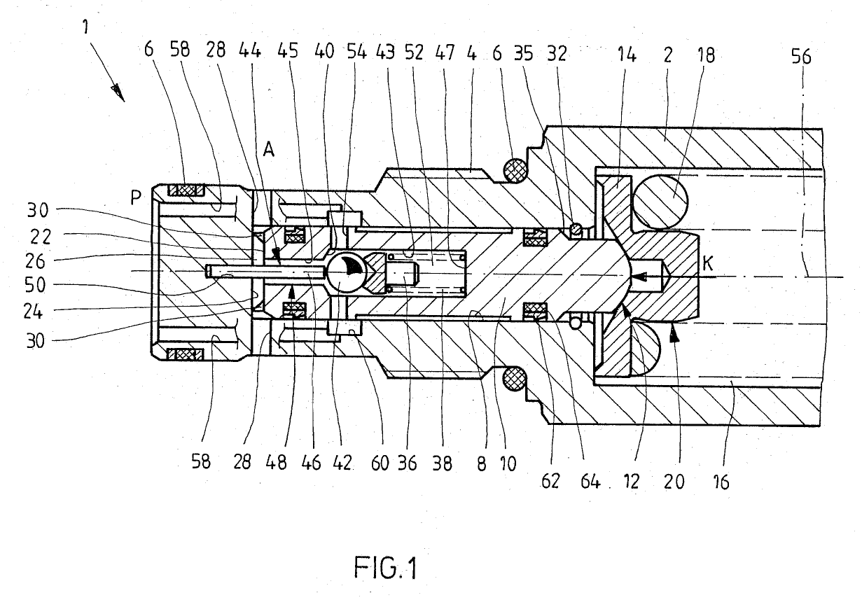

FIG. 1 shows a longitudinal cross section through an inventive pressure reducing valve 1 with a cartridge-shaped valve housing 2 which can be screwed into a control block housing (not shown) via a thread 4. Valve housing 2 has three regions with stepped diameters, which interact with a corresponding stepped bore in the control block housing. An end-face pressure inlet P (pump connection) and a regulating pressure outlet A of valve housing 2 are sealed off from each other via sealing rings 6. Valve housing 2 has a stepped, nearly blind hole-like valve bore 8 in which a control plunger 10 capable of being acted upon against an adjustable force K from a regulating pressure is accommodated in an axially displaceable manner.

With the exemplary embodiment shown, control plunger 10 bears against a spring plate 14 in the closing direction via a ball-shaped end section 12, and via this, is loaded by the force of a control spring 18 located in a spring chamber 16, which is supported via an adjusting spindle (not shown) screwed into valve housing 2 to change the spring preload, i.e., force K. Spring plate 14 includes a supporting section 20 which is adapted to the inner contour of control spring 18 in sections to accommodate control spring 18; supporting section 20 penetrates spring 18 to a partial extent.

With a not-shown exemplary embodiment of the present invention, force K is applied to control plunger 10 via a proportional magnet.

Control plunger 10 borders—via an end face 22, with a base surface 24 of valve bore 8—a control chamber 26 which is connected with regulating pressure outlet A via several control channels 28 which lie in a radial plane. End surface 22 of control plunger 10 is provided with projections 30 formed by a breakthrough groove to separate it from base surface 24 of valve bore 8. As a result, control plunger 10 does not rest flat against the surface and is acted upon by pressure in control chamber 26 against the force of control spring 18. Fluid channels are also formed as a result. The path of control plunger 10 is limited by a snap ring 32 inserted in the circumferential wall of valve bore 8, against which control plunger 10 moves via a diagonal stop surface 35 after a defined length of displacement travel.

Pressure reducing valve 1 includes a closing body 42 which is preloaded in the closing direction via a spring support 36 by the force of a compression spring 38 in the direction of a valve seat 40. Closing body 42 can be moved past valve seat 40 via a transfer element 44 out of its closed position and into its opened position shown. A pressure medium connection from pressure inlet P to regulating pressure outlet A is therefore controlled via control plunger 10, which interacts with closing body 42. According to the present invention, control plunger 10 is designed as a hollow piston in order to accommodate closing body 42, and it forms valve seat 40 for closing body 42, which is guided in control plunger 10.

The means for attaining the object of the present invention provides a short overall length of pressure reducing valve 1 by locating closing body 42 in control plunger 10. Control plunger 10 has a valve 43 that accommodates closing body 42 and leads into an axial bore 45 in the region of valve seat 40. On the end opposite to valve seat 40, valve bore 43 is bordered by a contact surface 47 for compression spring 38. To insert closing body 42, control plunger 10 can have, e.g., a two-component design, or it can have an insertion opening (not shown) that is closed using a screw-in stopper.

In the exemplary embodiment shown, a housing-mounted plunger 46 is used as transfer element 44, which supports closing body 42, e.g., a ball, in the position shown, past valve seat 40 and against the force of compression spring 38. Plunger 46 is fixed in position in a receiving bore 50 of valve housing 2 and, in the spring-preloaded home position of control plunger 10 shown, extends out of valve seat 40 and into inner space 52 of control plunger 10, thereby lifting closing body 42 away from valve seat 40. Plunger 46 penetrates valve seat 40 in the center and has a diameter that is less than the diameter of valve seat 40, thereby resulting in an annular flow channel 48 between plunger 46 and the bore of valve seat 40. Inner space 52 of control plunger 10 is connected with pressure inlet P via radial bores 54 in the region of valve seat 40.

To this end, pressure inlet P is hydraulically connected with radial bores 54 via pressure channels 58 which extend parallel to a longitudinal axis 56 of pressure reducing valve 1 and lead into an annular channel 60 in the region of radial bores 54. In the region of closing body 42, radial bores 54 lead into inner space 52 of control plunger 10. Control plunger 10 is sealed off from valve bore 8 via radial seals 62. Regulating pressure outlet A is therefore sealed off from pressure inlet P, and pressure inlet P is sealed off from spring chamber 16. To this end, an annular groove 64—which is designed nearly as a U-shaped notch—is provided to accommodate radial seals 62 between pressure inlet P and regulating pressure outlet A, and between pressure inlet P and spring compartment 16.

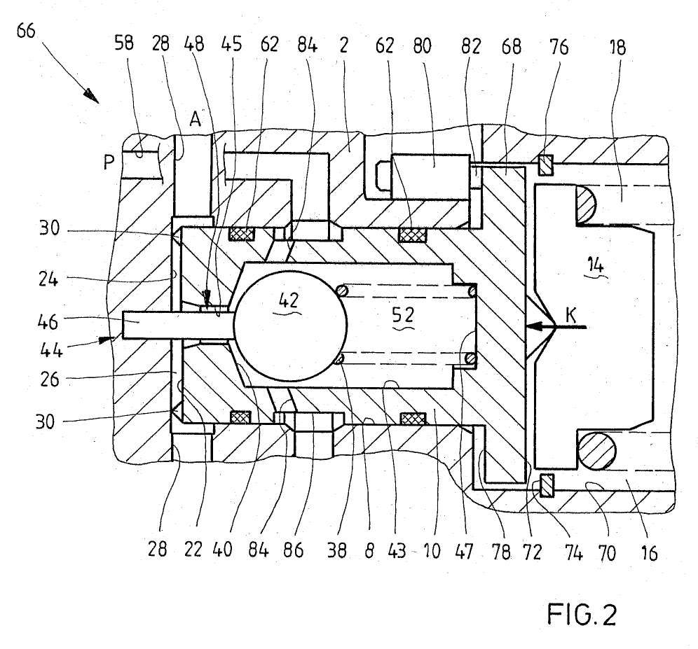

FIG. 2 shows a longitudinal cross section through an inventive pressure reducing valve 66 according to a further exemplary embodiment. This exemplary embodiment differs from the exemplary embodiment described previously mainly by the fact that control plunger 10 includes a radial collar 68 which dips into spring compartment 16 and has a diameter that is smaller than the diameter of a bore section 70 of valve bore 8 in the region of spring compartment 16. In bore section 70, the axial displacement travel of control plunger 10 is limited in the direction of control spring 18 via a stop surface 72 of radial collar 68 by a contact surface 74 of a stop 76 which is inserted in bore section 70. When the adjusting spindle (not shown) is rotated outward, control plunger 10 reaches—via contact surface 72—stop shoulder 74 of stop 76 and stops following the adjusting spindle (minimal preload on control spring 18).

Radial collar 68 can be brought to bear against a pressure monitoring sensor 80 via an annular end face 78 which faces away from spring compartment 16; pressure monitoring sensor 80 follows the displacement travel of control plunger 10 via a sliding element 82. Inner space 52 of control plunger 10 is hydraulically connected with pressure inlet P via diagonally extending radial bores 54. To this end, in the region of closing body 42, radial bores 84 lead into inner space 52 of control plunger 10, into a circumferential annular groove 86 that is provided on the outer circumference of control plunger 10 and is connected with pressure inlet P via pressure channel 58.

The function of pressure reducing valve 1, 66 is described below briefly with reference to FIG. 2, to improve the understanding of it.

In the spring-preloaded home position of pressure reducing valve 66 shown in FIG. 2, control plunger 10 bears against base surface 24 of valve bore 8 via projections 30. Housing-mounted plunger 46 penetrates valve seat 40 in the center and, in the spring-preloaded home position of control plunger 10 shown, extends past valve seat 40 and into inner space 52 of control plunger 10, thereby lifting closing body 42 away from valve seat 40. Since the diameter of plunger 46 is smaller than that of valve seat 40, annular flow channel 48 is formed between plunger 46 and bore 45 of valve seat 40, so that a pressure medium connection is opened between pressure inlet P to regulating pressure outlet A. End face 22 of control plunger 10 is acted upon by the regulating pressure. The level of regulating pressure at regulating pressure outlet A that is required to actuate the control plunger in its closed position depends on the preload force of control spring 18, which can be changed by adjusting the adjusting spindle.

Once the adjusted system limiting pressure has been reached, control plunger 10 is displaced via the pressure acting on end face 22 to the right until closing body 42—which is preloaded against plunger 46 via compression spring 38—comes to rest against valve seat 40, and the connection between pressure inlet P and regulating pressure outlet A is established. Radial collar 68 of control plunger 10 is now brought to bear against stop 16 via stop surface 72. Sliding element 82 of pressure monitoring sensor 80 follows the motion of control plunger 10 and signals that the regulating outlet pressure—which is required, e.g., for a clamping device—has been reached. If the pressure drops at regulating pressure outlet A, e.g., due to loss of pressure in the clamping device, below the value set via control spring 18, control plunger 10 is displaced to the left by the force of control spring 18, and closing body 42 is lifted away from valve seat 40 by housing-mounted plunger 46.

As a result, the flow cross-section between closing body 42 and valve seat 40 is established, and regulating pressure outlet A is supplied with pressure medium via pressure inlet P until the desired regulating pressure at regulating pressure outlet A has been reached. The pressure in control chamber 26 rises again to the adjusted regulating pressure value. As a result, control plunger 10 is returned to its closed position, and closing body 42 interrupts the connection between pressure inlet P and regulating pressure outlet A at valve seat 40.

Inventive pressure reducing valve 1, 66 is not limited to closing ball 42 described. Instead, practically any closing element known from the related art can be used, particularly a closing ball. It is also possible to adapt the shape of control plunger 10 to the particular valve types.

The present invention relates to a pressure reducing valve 1, 66, for a clamping device in particular, with a control plunger 10, which is acted upon against an adjustable force by a regulating pressure, and with a closing body 42, which is preloaded against a valve seat 40 in the closing direction by the force of a compression spring 38. The closing body 42 is capable of being moved from its closed position into its opened position, past valve seat 40, via a transfer element 44, thereby allowing control of the flow of pressure medium from a pressure inlet P to a regulating pressure outlet A. According to the present invention, control plunger 10 is designed as a hollow piston in order to accommodate closing body 42, and it forms valve seat 40 for closing body 42, which is guided in control plunger 10.

It will be understood that each of the elements described above, or two or more together, may also find a useful application in other types of constructions differing from the type described above.

While the invention has been illustrated and described as embodied in a pressure reducing valve, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A pressure reducing valve, comprising a pressure inlet; a regulating pressure outlet; a control plunger which is acted upon against an adjustable force by a regulating pressure; a valve seat; a compression spring; a transfer element; a closing body which is preloaded against said valve seat in a closing direction by a force of said compression spring and which is movable from its closed position into its open position past said valve seat via said transfer element thereby allowing control of a flow of pressure medium from said pressure inlet to said regulating pressure outlet, said control plunger being configured as a hollow piston for accommodating said closing body and forming said valve seat for said closing body, which is guided in said control plunger.

2. A pressure reducing valve as defined in claim 1, wherein said control plunger is guided in a valve bore and, with this and via an end face, it borders a control chamber that is acted upon by the regulating pressure.

3. A pressure reducing valve as defined in claim 2; and further comprising at least one control channel which connects said control chamber with said regulating pressure outlet.

4. A pressure reducing valve as defined in claim 1, wherein said transfer element is configured as a housing-mounted plunger which supports said closing body in its opened position past said valve seat against the force of said compression spring.

5. A pressure reducing valve as defined in claim 1, wherein said closing body is configured as a ball.

6. A pressure reducing valve as defined in claim 1, wherein said control plunger has an inner space which is acted upon by an inlet pressure via at least one radial bore.

7. A pressure reducing valve as defined in claim 1; and further comprising radial bores which lead into an inner space of said control plunger in a region of said closing body.

8. A pressure reducing valve as defined in claim 7, wherein said radial bores lead into a formation selected from the group consisting of a circumferential annular groove provided on an outer circumference of said control plunger and connected with said pressure inlet via at least one pressure channel, and at least one pocket.

9. A pressure reducing valve as defined in claim 1; and further comprising a pressure monitoring sensor, said control plunger being operatively connected with said pressure monitoring sensor.

10. A pressure reducing valve as defined in claim 9, wherein said pressure monitoring sensor is an electrical switch.

11. A pressure reducing valve as defined in claim 1; and further comprising at least one housing-mounted stop, said control plunger including a radial collar which interacts with said at least one housing-mounted stop.

12. A pressure reducing valve as defined in claim 1; and further comprising a pressure monitoring sensor, said control pressure actuating said pressure monitoring sensor via a radial collar.

13. A pressure reducing valve as defined in claim 1; and further comprising means providing a force acting on said control plunger in an opening direction and selected from the group consisting of one control spring and a proportional magnet.

14. A pressure reducing valve as defined in claim 13; and further comprising an adjusting element which adjusts a preload on said control spring in order to change a regulating pressure.

15. A pressure reducing valve as defined in claim 13, wherein said adjusting element is configured as an adjusting spindle.

16. A pressure reducing valve as defined in claim 1; and further comprising at least one radial seal which seals said pressure inlet against said regulating pressure outlet against a chamber with a control spring or a proportional magnet.

17. A pressure reducing valve as defined in claim 1, wherein the pressure reducing valve is configured as a pressure reducing valve for a clamping device.
